(19) United States
(12) Patent Application Publication
(10) Pub. No.: US 2011/0238784 A1
(43) Pub. Date: Sep. 29, 2011

(54) MANAGEMENT APPARATUS AND METHOD THEREFOR

(75) Inventor: Satoshi Takazawa, Kawasaki-shi (JP)

(73) Assignee: CANON KABUSHIKI KAISHA, Tokyo (JP)

(21) Appl. No.: 13/055,135

(22) PCT Filed: Oct. 19, 2010
(86) PCT No.: PCT/JP2010/006184

§ 371 Date: Jan. 20, 2011

(30) Foreign Application Priority Data
Nov. 4, 2009 (JP) 2009-253075

(51) Int. Cl. G06F 15/173; G06F 15/16

(52) U.S. Cl. 709/217; 709/224

(57) ABSTRACT

A management apparatus that communicates with a client apparatus on which a management program for managing network devices operates includes a determination unit that determines whether or not a network device has a function for providing a page of device information indicative of information relating to the network device; and a transmission unit that transmits link information about a link to the page of the device information to the client apparatus when the determination unit determines that the network device has the function for providing the page of the device information, and that transmits link information that allows checking of device information held in the management apparatus to the client apparatus when the determination unit determines that the network device does not have the function for providing the page of the device information.

### TECHNICAL FIELD

The present invention relates to a technique for implementing the function of a management apparatus configured to manage network devices to dynamically change the display of a screen on an information processing apparatus such as a personal computer (PC) connected to the management apparatus in accordance with the state or the like of the network devices.

### BACKGROUND ART

Recent network devices including printers, scanners, and multi-function peripherals (MFPs) are connected to a management apparatus configured to manage the network devices via various interfaces such as a local area network (LAN) interface and a universal serial bus (USB) interface. In the related art, a management apparatus includes a user interface (UI) configured to manage network devices (see, for example, PTL 1). The management apparatus is capable of performing processing such as checking the state of occurrence of errors in devices, checking the remaining amount of toner, and changing settings via the UI.

Recent novel management methods for network devices include the Device Stage installed in Microsoft Windows (registered trademark) 7. The Device Stage allows a user to operate an information processing apparatus connected to a network device to perform operations such as using network devices. The Device Stage provides users with interfaces unique to network devices by defining information using extensible markup language (XML) metadata.

The Device Stage allows users to create links to interfaces unique to network devices and to go to the manufacturers' websites or support pages from the links Information about the links may be written to XML metadata directly or indirectly by referring to environment variables. However, since XML metadata is used for general-purpose applications, it is difficult to set a link destination including information that is different depending on the user's environment (for example, an Internet Protocol (IP) address).

### CITATION LIST

### Patent Literature

PTL 1: Japanese Patent Laid-Open No. 9-153017

### SUMMARY OF INVENTION

### Technical Problem

The present invention provides a function (for example, the Device Stage) for managing network devices, which operates on an information processing apparatus, in which link information that requires unique information or the like set in a network device is dynamically set.

According to an aspect of the present invention, a management apparatus that communicates with a client apparatus on which a management program for managing a network device operates includes a determination unit configured to determine whether or not a network device has a function for providing a page of device information indicative of information relating to the network device; and a transmission unit configured to transmit link information about a link to the page of the device information to the client apparatus when the determination unit determines that the network device has the function for providing the page of the device information, and configured to transmit link information that allows checking of device information held in the management apparatus to the client apparatus when the determination unit determines that the network device does not have the function for providing the page of the device information. In the client apparatus, the information relating to the network device is checked by using the transmitted link information via the management program.

Further features of the present invention will become apparent from the following description of exemplary embodiments with reference to the attached drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a diagram illustrating the overall configuration of a management system configured to manage network devices.

FIG. 2 illustrates the hardware configuration of a general-purpose computer.

FIG. 3 illustrates the software configuration of a management apparatus.

FIG. 4 illustrates the hardware configuration of a network device.

FIG. 5 illustrates the software configuration of the network device.

FIG. 6 illustrates the software configuration of a client apparatus.

FIG. 7 illustrates examples of relation information managed by the management apparatus.

FIG. 8 is a flowchart illustrating a process of the management apparatus when a printer driver is installed.

FIG. 9 is a flowchart illustrating a process of a driver agent in the client apparatus.

FIG. 10A is a flowchart illustrating a process for determining a link destination using the management apparatus.

FIG. 10B is a flowchart illustrating a process for determining a link destination using the management apparatus.

FIG. 11 is a flowchart illustrating a process performed when an executable file is executed.

FIG. 12 illustrates a flow of an overall process in the system.

FIG. 13 illustrates an example of a user interface for creating a task.

FIG. 14A illustrates an example of display before a link destination is registered.

FIG. 14B illustrates an example of display after a link destination is registered.

FIG. 15A illustrates an example of display of a link destination in a PUSH mode.

FIG. 15B illustrates an example of display of link destinations in a PULL mode.

FIG. 16 is a flowchart illustrating a process of a management apparatus according to a second embodiment.

FIG. 17 is a flowchart illustrating a process of a driver agent in a client apparatus according to the second embodiment.

FIG. 18A illustrates information regarding link destinations held in the management apparatus according to the second embodiment.

FIG. 18B illustrates information regarding link destinations held in the management apparatus according to the second embodiment.

### DESCRIPTION OF EMBODIMENTS

Exemplary embodiments of the present invention will be described hereinafter with reference to the drawings. In the following description, a user interface installed in a network device may also be referred to simply as a “Web page”.

### First Embodiment

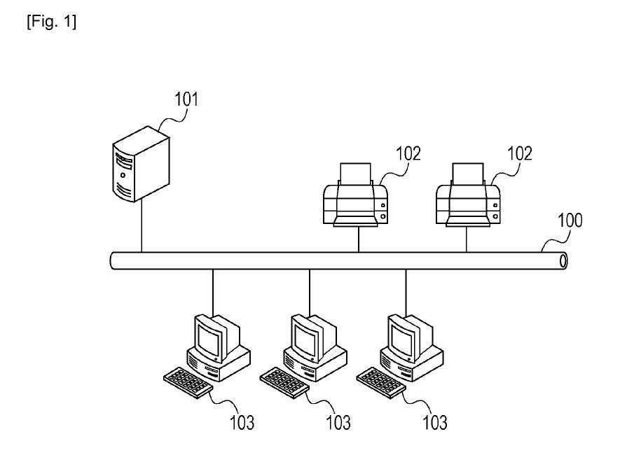

FIG. 1 is a diagram illustrating the overall configuration of a management system according to the present invention. The management system includes a management apparatus 101, network devices 102, and client apparatuses 103, which are connected to one another via a network 100. Each of the management apparatus 101 and the client apparatuses 103 has the configuration of a general-purpose computer. The network devices 102 are connected to the management apparatus 101 via the network 100, and are devices that can be managed by the management apparatus 101, including printers, MFPs, and facsimile machines.

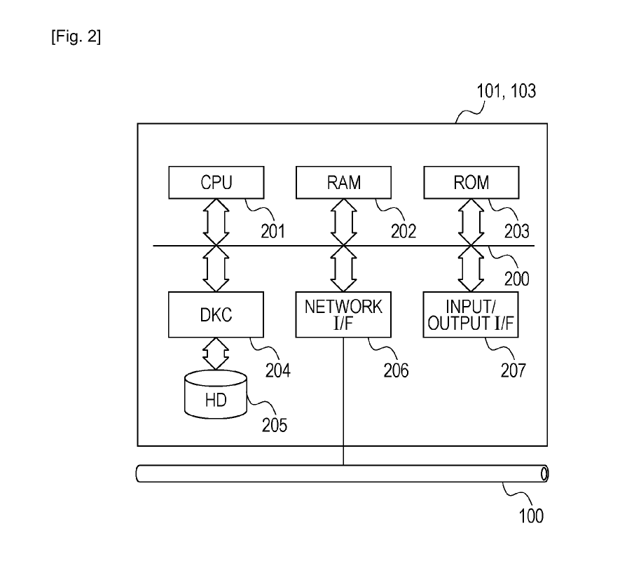

FIG. 2 illustrates a hardware configuration of a general-purpose computer (information processing apparatus) which may be each of the management apparatus 101 and the client apparatuses 103.

A system bus 200 may be a common data exchange path between components forming the computer. A central processing unit (CPU) 201 is a device configured to control the overall operation of the computer and perform processing such as computation processing. A random access memory (RAM) 202 refers to an area in which a program or data is stored and executed when processing is performed. A read only memory (ROM) 203 is an area in which a program such as a system boot program is stored. A disk controller (DKC) 204 controls an external storage device such as a hard disk (HD) 205. The HD 205 stores a program and data, and the program and data are loaded into the RAM 202 or the HD 205 as required. A network interface (I/F) 206 is connected to the network 100, and performs network communication. An input/output I/F 207 is connected to a keyboard, a mouse, a display, or the like, and is configured to input and output data.

The management apparatus 101 operates in a state where the CPU 201 is executing basic input/output (I/O) program and an operating system (OS). The basic I/O program is stored in the ROM 203, and the OS is stored in the HD 205. When the computer is powered on, the OS is loaded into the RAM 202 from the HD 205 by using the initial program loading function in the basic I/O program, and the operation of the OS is started.

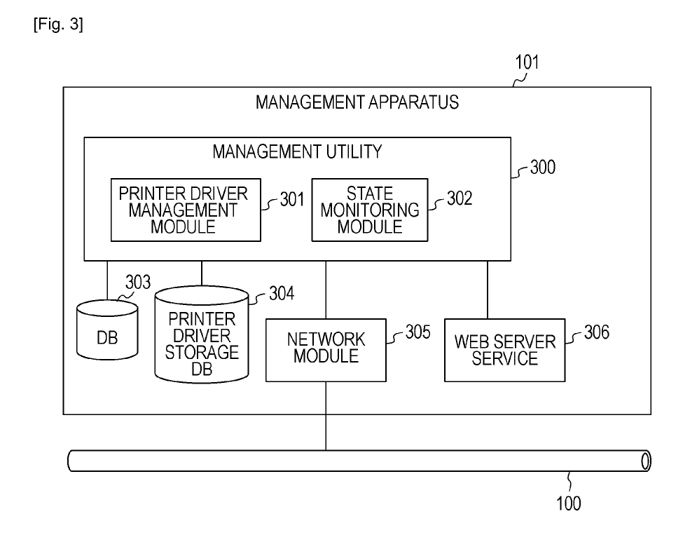

FIG. 3 illustrates the software configuration of the management apparatus 101.

The software of the management apparatus 101 includes a management utility 300, a database service (hereinafter referred to as a “DB”) 303, a printer driver storage DB 304, a network module 305, and a Web server service 306. The software configuration illustrated in FIG. 3 is stored as a program in the HD 205, and modules that are implemented by executing the program using the CPU 201 are illustrated.

The management utility 300 includes a printer driver management module 301 and a state monitoring module 302.

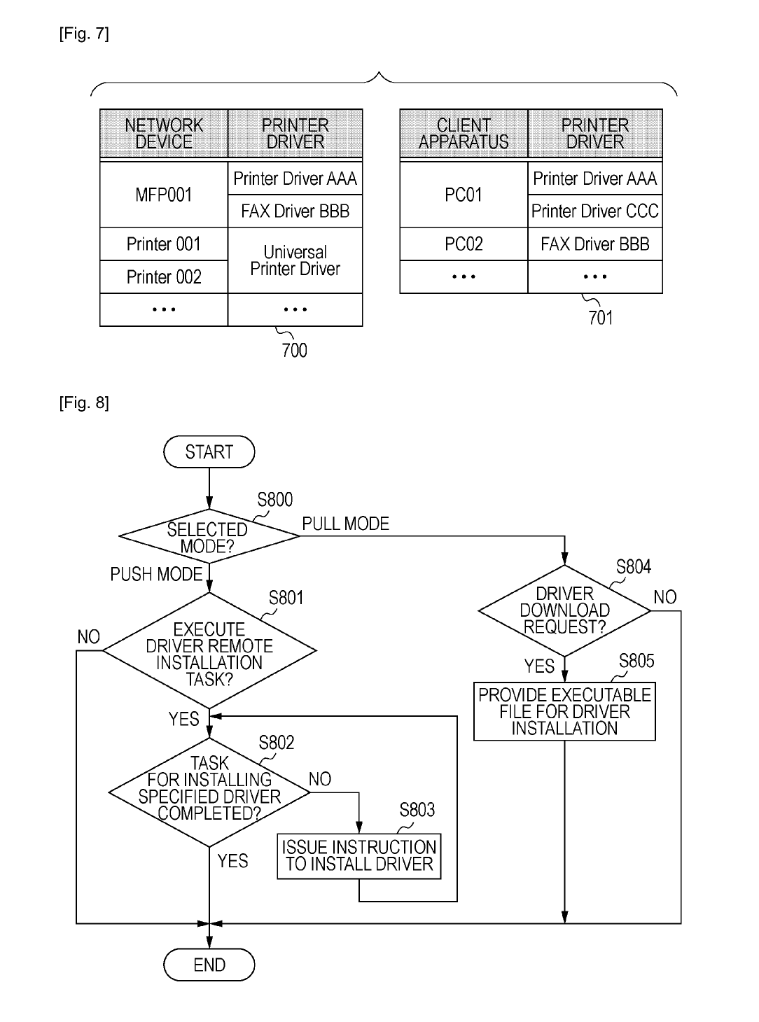

The printer driver management module 301 is a module for managing printer drivers stored in the printer driver storage DB 304. The printer driver management module 301 also handles relation information such as information about the relation between printer drivers and the network devices 102 and information about the relation between printer drivers and the client apparatuses 103. The above relation information may be that illustrated in FIG. 7 described below, and is stored in the DB 303.

The state monitoring module 302 is a module for monitoring the state of the network devices 102. The DB 303 stores information about the relation between printer drivers and the network devices 102 and information about the relation between printer drivers and the client apparatuses 103. The DB 303 also stores various setting information or the like obtained from a network device 102 to be managed.

The printer driver storage DB 304 is a database for storing printer drivers required to operate the network devices 102 on the client apparatuses 103. The DB 303 and the printer driver storage DB 304 may be placed in a device different from the management apparatus 101 if the DB 303 and the printer driver storage DB 304 can be accessed from the printer driver management module 301 or from the state monitoring module 302. The network module 305 communicates with the network devices 102 or client apparatuses 103 that are connected via the network 100.

Upon receipt of a hypertext transfer protocol (HTTP) GET request from the Web browser of a client apparatus 103, the Web server service 306 provides a service for returning Web page data saved in the HD 205. The Web server service 306 allows a user to access the management apparatus 101 from outside via the network 100. The management apparatus 101 has the management utility 300 installed in the Web server service 306, and serves as a management apparatus by executing the management utility 300. The management utility 300 is also mounted as a program for, for example, executing processing in response to a request to a Web page provided by the Web server service 306. As described above, the management utility 300 implements, together with the Web server service 306, a Web application for managing the network devices 102.

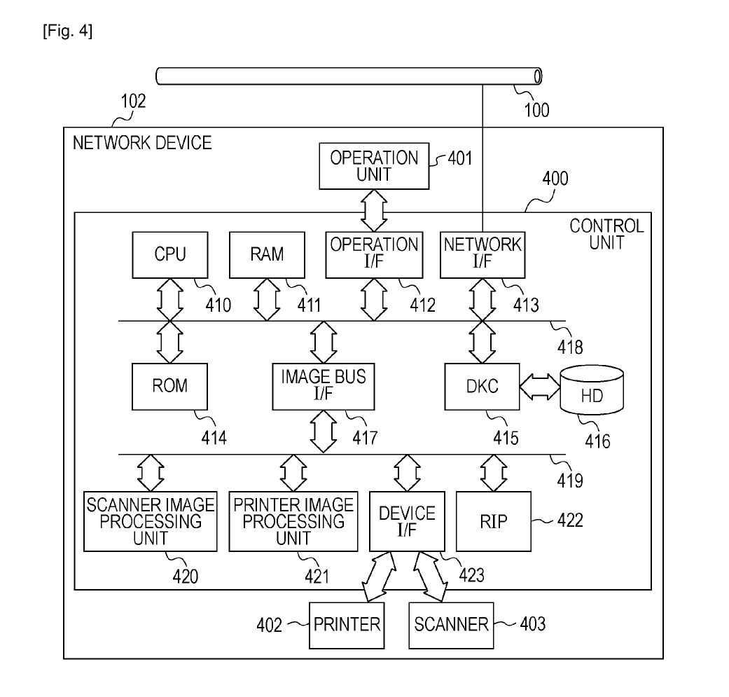

FIG. 4 is a diagram illustrating the hardware configuration of each of the network devices 102.

The network device 102 includes a control unit 400, an operation unit 401, a printer 402, and a scanner 403.

The configuration of the control unit 400, which is related to the operation unit 401, include a CPU 410, a RAM 411, an operation unit I/F 412, a network I/F 413, a ROM 414, a DKC 415, an HD 416, an image bus I/F 417, and a system bus 418. The configuration of the control unit 400, which is related to the printer 402 and the scanner 403, includes an image bus 419, a scanner image processing unit 420, a printer image processing unit 421, a raster image processor (RIP) 422, and a device I/F 423. In the above configuration, the scanner 403 and the scanner image processing unit 420 may be omitted. The CPU 410 is a controller configured to control the overall operation of the control unit 400. The RAM 411 is an image memory configured to temporarily store image data. The operation unit I/F 412 is an interface with the operation unit 401, and outputs image data to be displayed on the operation unit 401 to the operation unit 401. The operation unit I/F 412 also serves to transmit information input by a user using the operation unit 401 to the CPU 410. The network I/F 413 is an interface connected to the network 100 to exchange information with the network 100. Further, the network I/F 413 has a management information base (MIB) storing various information about the network device 102. The various information stored in the MIB may be information such as an IP address and the network device name. The ROM 414 is a boot ROM, and stores a boot program of the system. The DKC 415 controls the HD 416. The HD 416 is an external storage device configured to store system software and image data. The image bus I/F 417 is a bus bridge configured to connect the system bus 418 and the image bus 419 to perform data exchange therebetween. The system bus 418 is a common data exchange path between components forming the control unit 400. The image bus 419 may be a path formed of a peripheral component interconnect (PCI) bus or an Institute of Electrical and Electronic Engineers (IEEE) 1394 bus which allows high-speed transfer of image data. The scanner image processing unit 420 corrects, modifies, or edits an input image. The printer image processing unit 421 performs processing such as correction or resolution conversion on print output image data in accordance with the performance of the printer 402. The RIP 422 extends a page description language (PDL) command sent from the network 100 to a bitmap image. The device I/F 423 connects the printer 402 or the scanner 403, which may be an image input/output device, to the control unit 400, and performs synchronous-asynchronous conversion of image data.

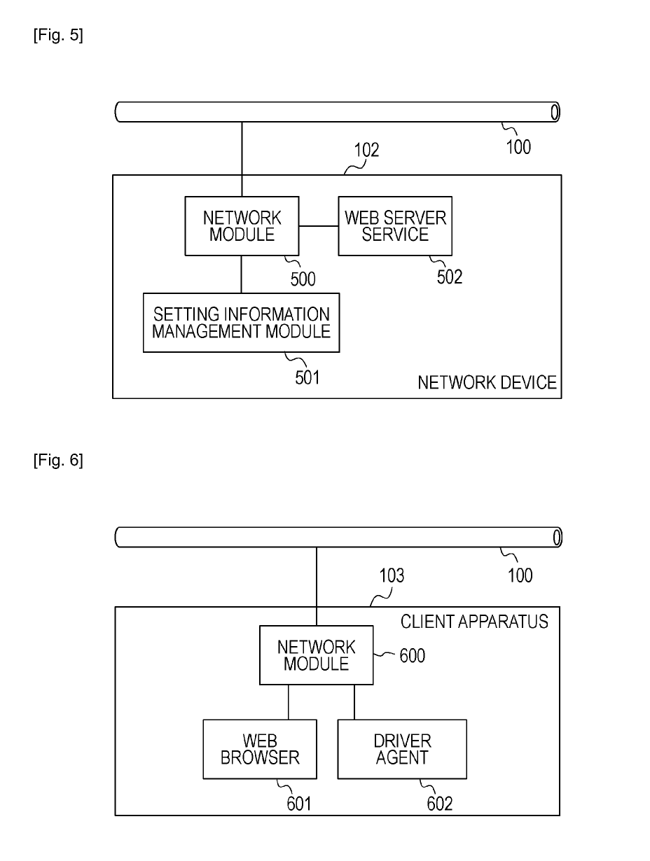

FIG. 5 is a diagram illustrating the software configuration of each of the network devices 102.

A network module 500 serves as an interface between the management apparatus 101 and the network device 102, which are connected to the network 100. For example, the network module 500 receives a search request from the management apparatus 101 via the network 100, and issues a request for obtaining setting information that is required to send a response to a setting information management module 501. The search request may be received using any network protocol such as Simple Network Management Protocol (SNMP), Service Location Protocol (SLP), or Web Services for Devices (WSD). The network module 500 receives setting information obtained from the setting information management module 501, and transmits the setting information as a response to the management apparatus 101 via the network 100. In response to a request received from the network module 500, the setting information management module 501 returns setting information stored in the RAM 411, the HD 416, or the MIB of the network I/F 413 to the network module 500. Upon receipt of an HTTP GET request from the management apparatus 101 or from the Web browser of a client apparatus 103, the Web server service 502 provides a service for returning Web page data saved in the HD 416 or the like.

The service for providing Web page data is not limited to a method for providing Web page data using the HTTP method, and Web page data may be provided using a method based on JavaScript or the like. Some network devices 102 have the function of the Web server service 502 and others do not.

FIG. 6 is a diagram illustrating the software configuration of each of the client apparatuses 103.

A network module 600 serves to interface with the management apparatus 101 and the client apparatus 103 that are connected to the network 100. A Web browser 601 is written in the HD 205 as a program, and is written into and executed in the RAM 202 on the OS. Access from the client apparatus 103 to the management apparatus 101 and the network devices 102 is performed by using the Web browser 601 via the network module 600. A driver agent 602 is a program installed by a user having administrator privilege for the client apparatus 103 from the management apparatus 101 into the client apparatus 103 via the network 100. The driver agent 602 may be remotely installed into the client apparatus 103 from the management apparatus 101, or may be downloaded and installed onto the client apparatus 103 by a user. The driver agent 602 provides settings that allow a printer driver to be installed into the client apparatus 103 from the management apparatus 101 to perform an operation such as a printing operation using the corresponding network device 102.

FIG. 7 illustrates information about the relation between the network devices 102 and printer drivers and information about the relation between the client apparatuses 103 and printer drivers, which are stored in the DB 303 of the management apparatus 101. Herein, a printer driver that can be used for general-purpose applications regardless of the type of the network device 102 is referred to as a “universal printer driver”. Examples of the universal printer driver include a printer driver that allows generation of data with the specified function and setting, which do not depend on the product type, using a common format and allows transmission of the data to a network device.

Information 700 indicates information about the relation between the network devices 102 and printer drivers, and indicates the correspondence between the network devices 102 and printer drivers required to use the network devices 102. The relation between the network devices 102 and printer drivers is not limited to one-to-one relation, and may include one-to-multiple relation, multiple-to-one relation, and multiple-to-multiple relation. The information 700 may be registered manually by a user who manages the management apparatus 101, or may be registered automatically.

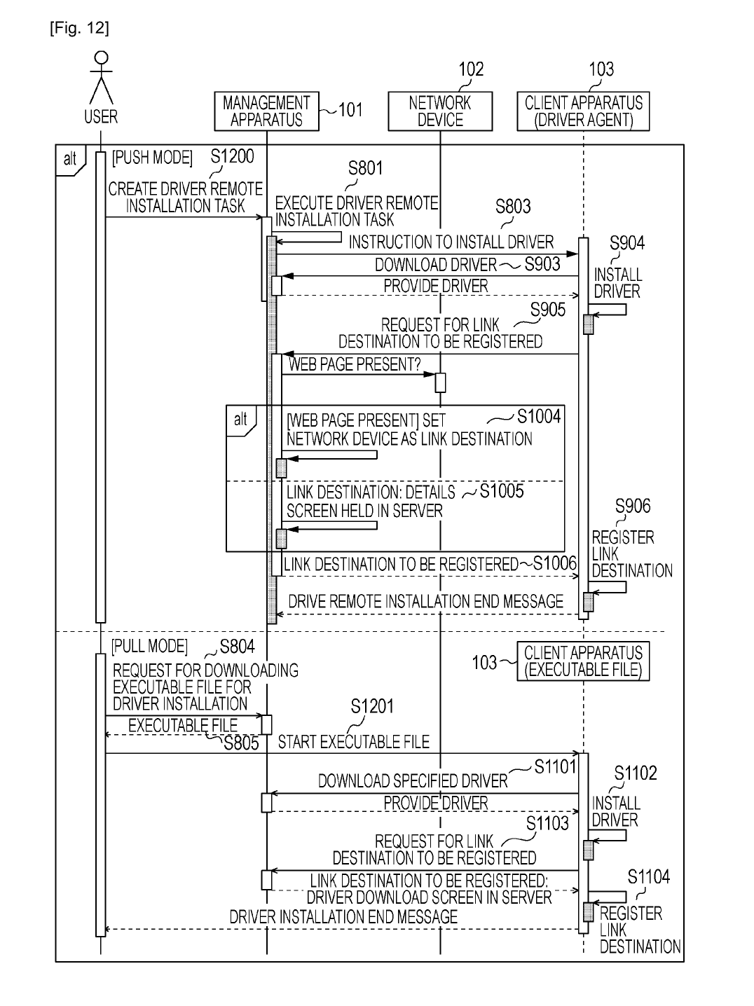

Relation information 701 indicates information about the relation between the client apparatuses 103 and printer drivers, and indicates which printer driver is currently installed in each of the client apparatus 103. The information 701 is registered and utilized as a task described below with reference to S1200 in FIG. 12.

FIGS. 8 to 12 illustrate a specific process flow according to this embodiment. FIG. 12 is a sequence diagram illustrating the overall process flow of the system.

FIG. 8 illustrates a process of the management apparatus 101 for installing a printer driver into a client apparatus 103. Steps illustrated in FIG. 8 are performed by the printer driver management module 301.

In S800, it is determined which of a PUSH mode and a PULL mode, which may be printer driver installation methods, a user has selected. If the PUSH mode has been selected, the process proceeds to S801. If the PULL mode has been selected, the process proceeds to S804.

The PUSH mode refers to a method in which a user installs a printer driver, through a remote operation, into a client apparatus 103 connected via the network 100 (hereinafter referred to as “remote installation”). Examples of the installation operation include a method in which on behalf of the management apparatus 101, the driver agent 602 included in the client apparatus 103 performs installation.

The PULL mode refers to a method in which an executable file for installing a printer driver is directly downloaded to a client apparatus 103 into which the printer driver is to be installed and in which the executable file is executed in response to an installation instruction made by a user. The executable file may not necessarily be downloaded directly, and may be distributed via e-mail to a local environment of a client apparatus 103 into which the printer driver is to be installed.

In S801, it is determined whether or not a remote installation task created by the user is executed. The term “task”, as used herein, is similar to the relation information 701 illustrated in FIG. 7, and is created at the timing of the processing of S1200 in FIG. 12. The remote installation task may be executed immediately or may be executed at a time specified by performing scheduling. If the task is executed, the process proceeds to S802. If the task is not executed, the process ends. In the process illustrated in FIG. 8, the process ends if the task is not executed. However, the process may wait in S801 for the execution of the task, or the determination of S801 may be performed when the execution of the task occurs as an event process. The process illustrated in FIG. 8 is merely an example. In S802, a determination, which is performed when the task created prior to the processing of S801 is a task for installing a plurality of printer drivers, is performed to check whether or not all processes to be executed in S803 described below have been completed. In S803, an instruction for installing a printer driver into the driver agent 602 included in a client apparatus 103 is made. Here, the processing of S802 and S803 may be processing for installing a printer driver into one client apparatus 103. However, an installation instruction may be issued to a plurality of client apparatuses at the same time.

The processing of S804 is executed when the PULL mode has been selected in S800, and it is determined whether or not the user has issued a printer driver download request. If a download request has been issued, the process proceeds to S805. If no download request has been issued, the process ends. In the process illustrated in FIG. 8, the process ends if no download request has been issued. However, the processing of S804 may be continuously performed until a download request is issued, or the determination of S804 may be performed when a request has occurred as an event. In S805, a user is provided with an executable file for installing a printer driver. In S805, information indicating which printer driver the provided executable file corresponds to may be held.

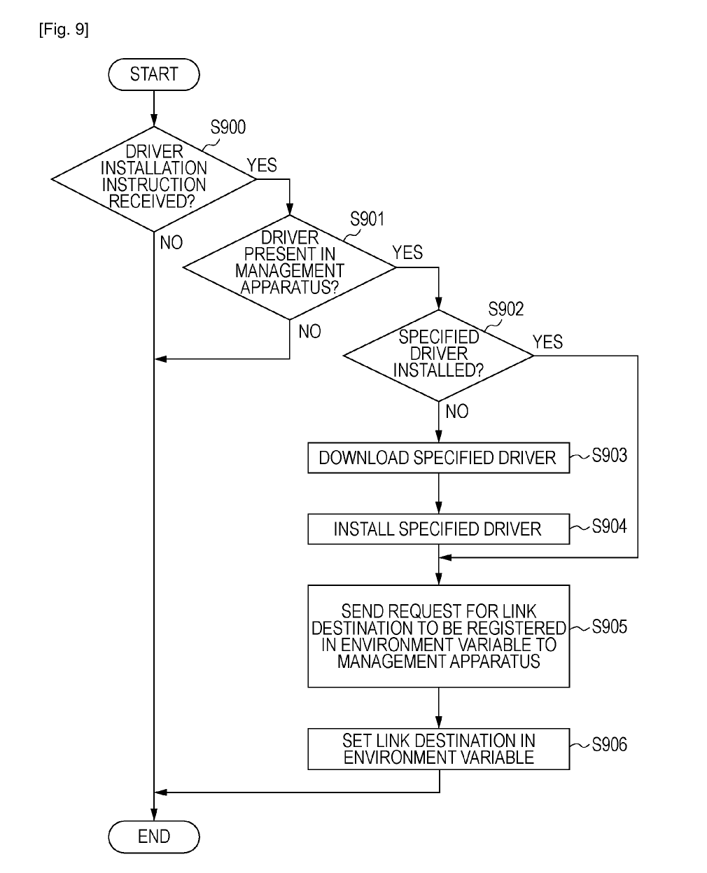

FIG. 9 illustrates a process executed by the driver agent 602 operating in the client apparatus 103.

In S900, it is determined whether or not a printer driver installation instruction has been received from the management apparatus 101. If an instruction has been received, the process proceeds to S901. If no instruction has been received, the process ends. The reception of an installation instruction corresponds to the processing of S803 in FIG. 8. In S901, it is checked and determined whether or not a printer driver (hereinafter referred to as a specified driver) specified in the installation instruction is present in the printer driver storage DB 304 of the management apparatus 101. If the specified driver is present in the management apparatus 101, the process proceeds to S902. If the specified driver is not present in the management apparatus 101, the process ends.

In S902, it is checked whether or not the specified driver has already been installed in the client apparatus 103. If the specified driver has already been installed, the process proceeds to S905. If the specified driver has not already been installed, the process proceeds to S903. In S903, the printer driver is downloaded into the client apparatus 103 from the printer driver storage DB 304 of the management apparatus 101. In S904, the printer driver downloaded in S903 is installed into the client apparatus 103.

In S905, a request for a link destination to be registered in an environment variable of the client apparatus 103 is sent to the management apparatus 101. In S906, information about a link destination returned as a response to the request sent in S905 is received, and the received link information is registered as an environment variable. In S905 and S906, the link destination is registered in an environment variable because it is assumed that an environment variable is set as a region referred to in advance by the management program (for example, the Device Stage) operating on the client apparatus 103. Therefore, if it is assumed that the region referred to by the management program is a registry, the received link information may be registered in the registry.

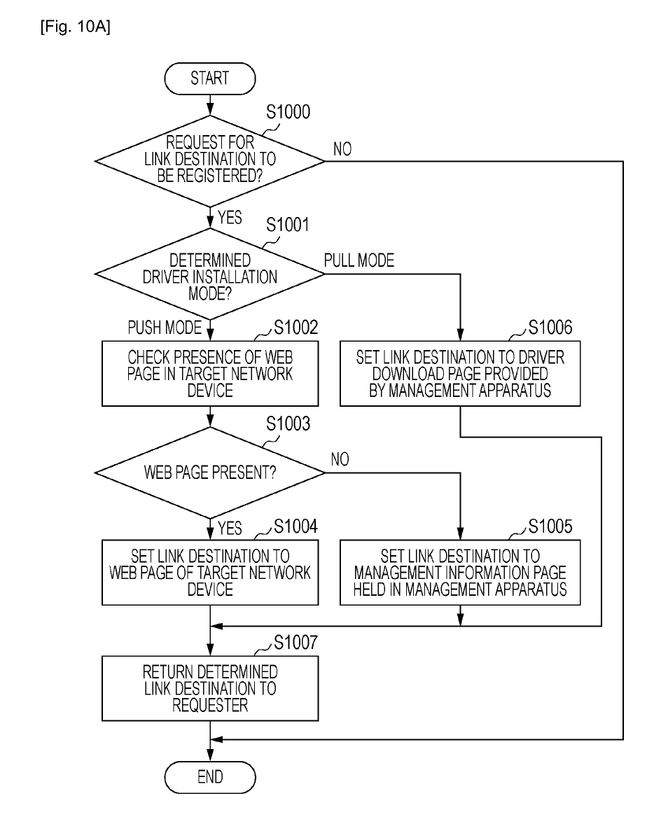

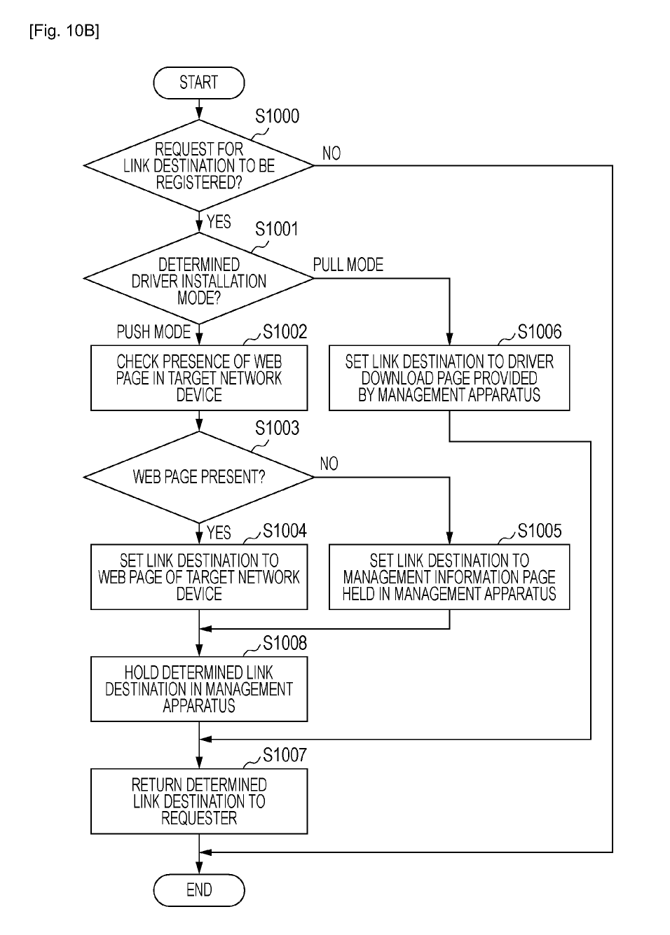

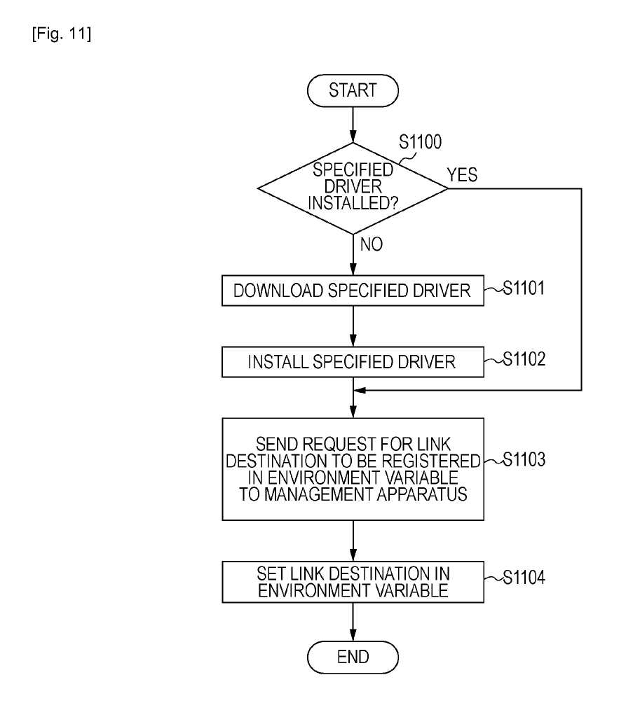

FIGS. 10A and 10B illustrate a process of the management apparatus 101 for determining a link destination to be registered in a client apparatus 103. The process corresponds to the process executed in response to a request issued in the processing of S905 in FIG. 9 and the processing of S1103 in FIG. 11 described below, and is performed by the printer driver management module 301. Here, in this embodiment, the process illustrated in FIG. 10A will be described. The process illustrated in FIG. 10B will be described in a second embodiment.

In S1000, it is determined whether or not a request for a link destination to be registered has been received by the management apparatus 101 from a client apparatus 103. If a request has been received, the process proceeds to S1001. If no request has been received, the process ends. Here, the process ends if no request for a link destination has been received. However, the processing of S1000 may be continuously performed until a request is received or the determination of S1000 may be performed when a request occurs as an event.

In S1001, it is determined whether the method for installing a printer driver is the PUSH mode or the PULL mode. Example of the determination method of S1001 include a method for causing the process to branch in accordance with the difference between the driver agent 602 and the executable file as link destination requesters because the request has been made from the driver agent 602 (PUSH mode) or the executable file (PULL mode). While the determination may be performed based on the difference between requesters, information about a selected mode may be included in a request and the determination may be performed based on the information. Alternatively, any other method may be used. If it is determined in S1001 that the selected mode is the PUSH mode, the process proceeds to S1002. If the selected mode is the PULL mode, the process proceeds to S1006.

In S1002, it is checked whether or not a target network device 102 serves to provide a Web page by using the Web server service 306. The provision of a Web page may be checked by transmitting a hypertext markup language (HTML) request. If the target network device 102 sends a response to the request, it may be determined that the target network device 102 serves to provide a Web page. Whether or not the target network device 102 serves to provide a Web page may be determined not only using an HTML request but also using an MIB or the like. In S1003, the next processing is determined in accordance with the determination result of S1002. If it is determined in S1002 that a Web page is present, the process proceeds to S1004. If a Web page is not present, the process proceeds to S1005. In S1004, the link destination to be registered in the requester is set to the Web page checked in S1002. For example, a Web page provided by a network device 102, including information unique to the network device 102 (for example, the IP address), is set as link destination. In S1005, the link destination to be registered in the requester is set to the detail information page of the network device 102, which is held in the management apparatus 101. Here, the detail information page of the network device 102 is as follows. Setting information obtained from the network device 102 is stored in the DB 303, and the stored data is provided as a Web page via the Web server service 306. While the Web page of the network device 102 allows real-time display of the state of the network device 102, the detail information page held in the management apparatus 101 refers to information at the time when the management apparatus 101 obtains information from the network device 102. There is a difference in time therebetween.

In S1006, in which the processing is performed if it is determined in S1001 that the PULL mode is set, the link destination to be registered in the requester is set to a driver download page that is provided by the management apparatus 101. Here, the driver download page is determined because of the following reasons. On the client apparatuses 103, a user himself/herself performs operations such as updating the printer driver and managing the version of the printer driver from now on. Therefore, link information about the link to the website from which the printer driver has been downloaded is set as the link destination to be registered in the requester to facilitate checking of up-to-date information about the printer driver.

In S1007, the link destination determined in the processing described above (S1004, S1005, and S1006) is transmitted to the requester as a response.

The link destination to be registered in the requester is not limited to that described herein, and may be a link to other functions or the like of the management apparatus 101. Furthermore, in FIG. 10A, the process branches in accordance with the conditions only based on the PUSH mode or the PULL mode. However, the process may also branch using user privilege information or the like.

FIG. 11 illustrates an operation performed when a client apparatus 103 executes the executable file provided in S805 of FIG. 8. The operation may be performed by a CPU in the client apparatus 103.

In S1100, it is determined whether or not the client apparatus 103 that started the executable file has installed therein a printer driver (specified driver) specified in the executable file (or by a user). If the specified driver has been installed, the process proceeds to S1103. If no specified driver has been installed, the process proceeds to S1101.

In S1101, the specified driver is downloaded from the management apparatus 101. In S1102, the printer driver obtained in S1101 is installed into the client apparatus 103. Thus, the corresponding network device 102 can be utilized via the specified driver.

In S1103, a request for a link destination to be registered in the environment variable in the client apparatus 103 is sent to the management apparatus 101. In S1104, the link destination returned in response to the request sent in S1103 is registered as an environment variable. In S1103 and S1104, a destination in which the link destination is to be registered is set as an environment variable. However, the link destination may be registered in any other location such as a registry.

FIG. 12 illustrates a flow of the overall process described with reference to FIGS. 8 to 11 including a user operation.

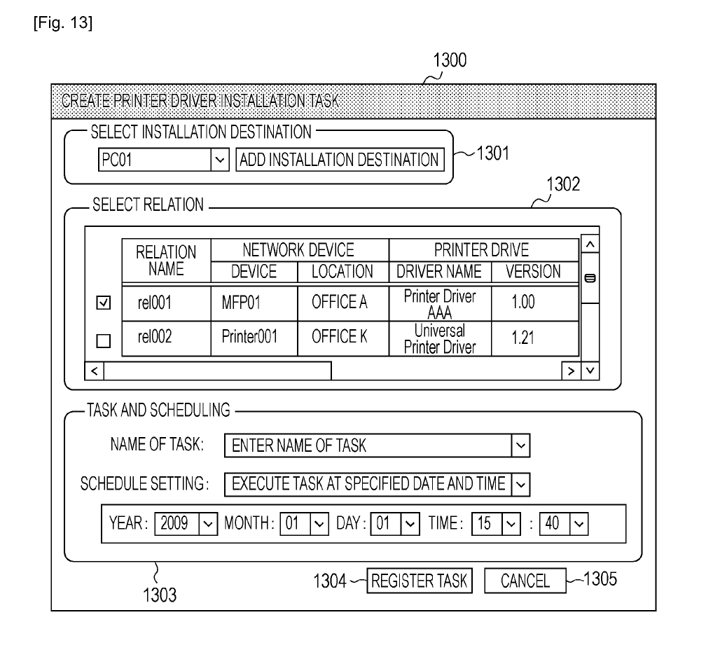

Here, the process starts by, as a user operation, selecting in which of the PUSH mode and the PULL mode a printer driver is installed by accessing the management apparatus 101. In FIG. 12, portions redundant to those described above are omitted or will be described briefly. Further, a specific example of a screen in the process will be described with reference to FIGS. 13 to 15B.

In S1200, a user creates a task for installing a printer driver into a client apparatus 103 after selecting the PUSH mode. The creation of a task will be described below with reference to FIG. 13. In S1201, the user issues an instruction to start the executable file downloaded into the client apparatus 103 after the selection of the PULL mode.

FIG. 13 illustrates an example of a user interface (hereinafter referred to as a “UI”) for creating a task. FIG. 13 can be separated into four parts including a UI 1300 for creating a printer driver installation task, an installation destination selection field 1301, a relation selection field 1302, and a task and scheduling setting field 1303. The UI 1300 may be provided by, for example, the management apparatus 101 as a Web page or may be provided as a native application within the management apparatus 101.

The UI 1300 for creating an installation task has a “register task” button 1304 for registering the configured task, and a “cancel” button 1305 for canceling a creation process halfway.

In the installation destination selection field 1301, a user selects a client apparatus 103 as an installation destination. The user selects an object into which the printer driver is to be installed from within a combo box. If there is no object into which the user wishes to install the printer driver, the user can press an “add installation destination” button to perform setting to add a target client apparatus 103 in the combo box. While the details of a method for adding an installation destination will not be described herein, required information such as a specified IP address and the name of the target client apparatus 103 is registered in the DB 303. Further, in the description of this embodiment, one apparatus into which a driver is to be installed is selected from within the combo box. However, the present invention is not limited thereto, the capability of selecting a plurality of apparatuses into which drivers are to be installed may be provided.

The relation selection field 1302 is a portion where a user selects a printer driver that the user wishes to install into a client apparatus 103. Here, the registered relation information 700 illustrated in FIG. 7 is displayed, and the user selects relation information about the relation between a printer driver into which the user wishes to install and a network device 102 which the user wishes to utilize.

The setting field 1303 is a portion where a user specifies the name of a task and a time zone during which the task is executed. Here, an option “execute the task at the specified date and time” is selected and displayed as an example of schedule setting. Any other option such as “execute the task immediately” or “execute the task on the specified day of the week” may also be selectable.

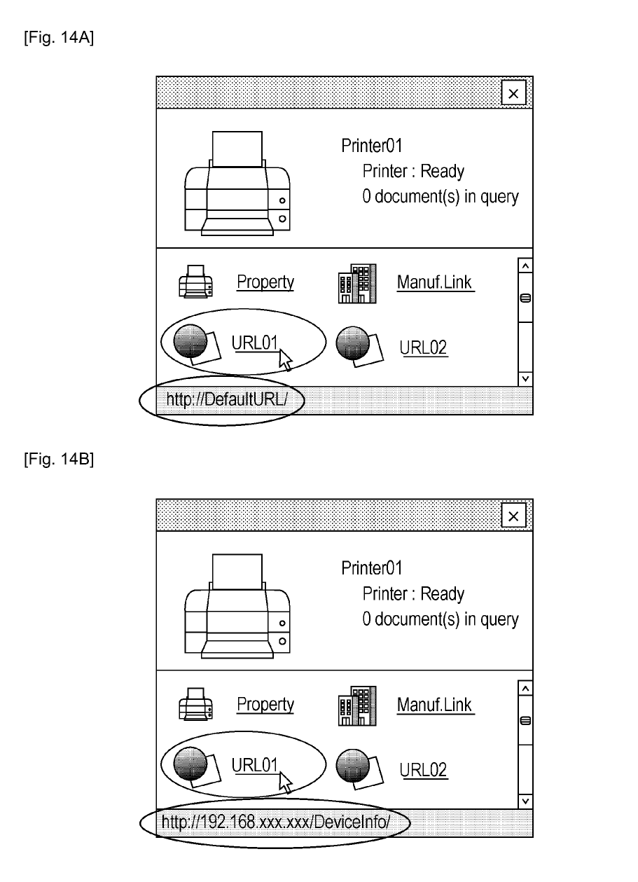

FIG. 14A illustrates an example of display before a link destination is registered, and FIG. 14B illustrates an example of display after a link destination is registered.

FIG. 14A illustrates an example of display before a link destination is registered in a client apparatus 103. In the example of display, link destination “http://DefaultURL/” is registered in URL01. This link destination represents a link destination that is initially registered in an environment variable. If no particular link destination is initially registered in an environment variable, nothing is displayed.

FIG. 14B illustrates an example of display after the link destination is set to the URL to the Web page of a network device 102 (S1004) and after the link destination is registered as an environment variable of the client apparatus 103. The URL01 is changed to “http://192.168.xxx.xxx/DeviceInfo/”, and here, the IP address of a target network device is embedded as a portion thereof.

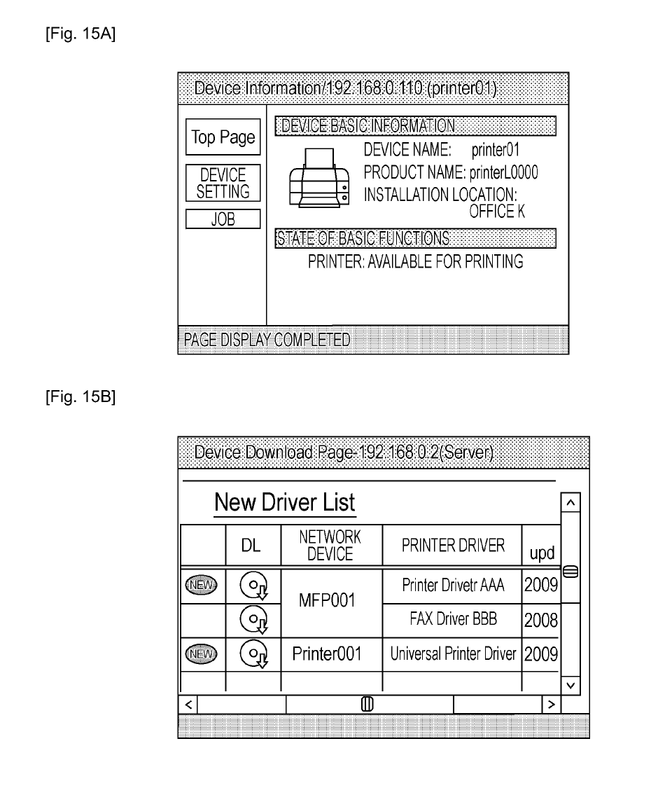

FIGS. 15A and 15B illustrate a difference between link destinations registered in a client apparatus 103.

FIG. 15A illustrates an example of display of a link destination in the PUSH mode. Here, the Web page screen (whose URL is “http://192.168.xxx.xxx/DeviceInfo/”) of the network device 102 is displayed. A user can use this screen to view the current status of the target network device.

FIG. 15B illustrates an example of display of link destinations registered as environment variables in S1104 in the PULL mode. A printer driver download screen is displayed, from which a user can download a new printer driver and can install the printer driver into a client apparatus 103.

As described above, a link destination on a management program of a network device, which operates on a client apparatus, can be dynamically changed in accordance with at least any determination such as determination based on the method for installing a printer driver or determination as to whether a network device has a Web page. The term “management program”, as used herein, means, for example, the Device Stage.

### Second Embodiment

In this embodiment, a method for changing a link destination registered according to the first embodiment in accordance with the state of a network device will be described. Further, the overall configuration of a system and the hardware configuration and the software configuration of a management apparatus 101, network devices 102, and client apparatuses 103 are similar to those in the first embodiment, and detailed descriptions thereof are omitted. Further, in initial registration of a link destination, which is performed during installation, the descriptions of potions redundant to those in the first embodiment are omitted.

FIG. 10B illustrates a process of the management apparatus 101 for determining a link destination to be registered in a client apparatus 103. The process, which may be different from the first embodiment, is performed by the printer driver management module 301. Here, only new processing in FIG. 10B will be described.

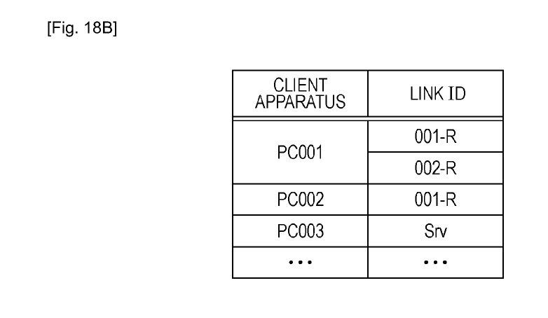

In S1008, a link destination to be registered in the client apparatus 103, which is determined on the management apparatus 101 side, is held. The information held here will be described below with reference to FIG. 18A.

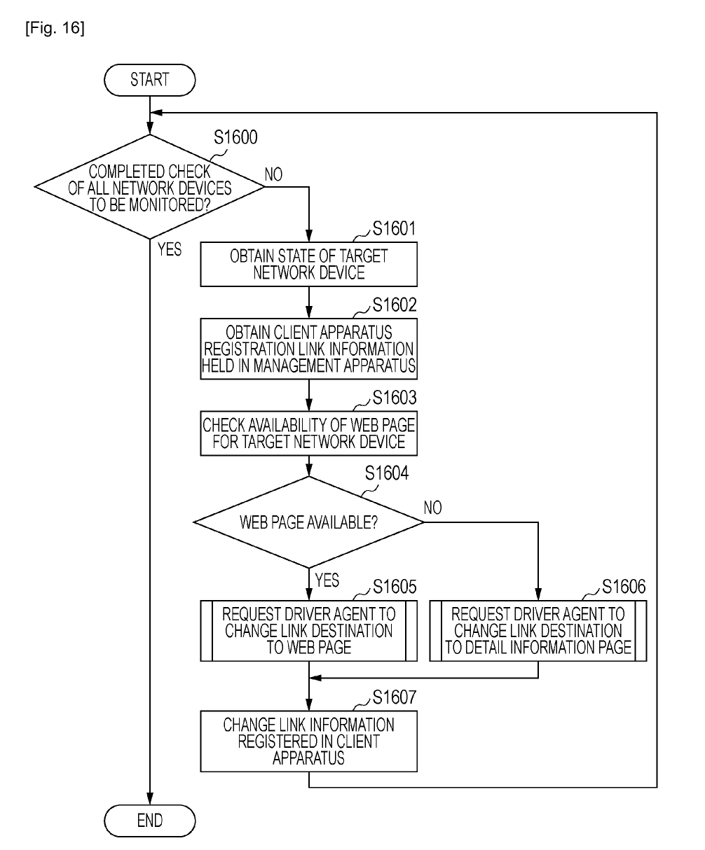

FIG. 16 illustrates a process of the management apparatus 101 when the management apparatus 101 monitors the state of the network devices 102. The process is performed by the state monitoring module 302. Examples of the state of a network device 102 to be monitored include the communication state between the management apparatus 101 and the network device 102 and the availability of a Web page of the network device 102.

In S1600, it is determined whether or not the checking of the state of all the network devices 102 to be monitored have been completed. Network devices 102 to be monitored are specified by a user, and information about the network devices 102 that are specified as objects to be monitored is held in the DB 303 or the HD 205. If the checking of all the network devices 102 to be monitored has been completed, the process ends. If the checking of all the network devices 102 to be monitored has not been completed, the processing of S1601 is executed on one of the network devices to be monitored.

In S1601, an attempt to perform communication with one network device to be monitored is made, and the communication state is obtained. With this process, the state of communication with the target device or the state of the target device such as an error can be obtained. In S1602, information (see FIG. 18B) indicating which client apparatus 103 the link about the network device 102 whose state has been checked is registered in is obtained.

In S1603, it is checked whether or not a Web page is available by using the Web server service 502 of the network device 102 whose state has been obtained in S1601. The availability of a Web page may be checked by issuing an HTML request and determining whether or not a response to the request is received. If a response to the request has been received, it can be determined that the Web page is available. The availability may be checked not only using an HTML request but also using an MIB or the like. In S1604, the determination processing is performed in accordance with the processing result of S1603. Here, if the Web page is available in accordance with the processing result of S1603, the process proceeds to S1605. If the Web page is not available, the process proceeds to S1606.

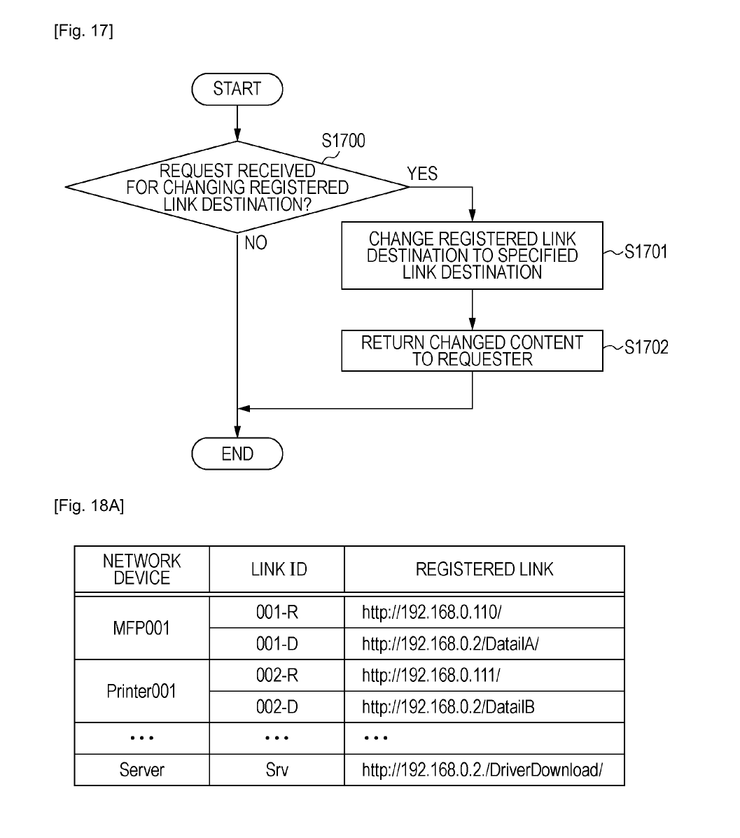

In S1605, a request for changing the registered link destination to the Web page of the target network device 102 is transmitted to the driver agent 602 of the client apparatus 103. In S1606, a request for setting the registered link destination to the detail information page of the network device 102, which is held in the management apparatus 101, is transmitted to the driver agent 602 of the client apparatus 103. The processing of the driver agent 602 in response to the request made in S1605 and S1606 will be described below with reference to FIG. 17.

In S1607, information about the registered link destination is updated in response to the request made in S1605 and S1606. Here, the object to be updated may be link information in which client apparatuses 103 have already been registered, which will be described below with reference to FIG. 18B. When the process ends, the process proceeds to the processing of S1600 to perform the process on the next network device 102 to be monitored.

The processing of S1601 to 1607 in FIG. 16 is performed on network devices 102 one by one. However, the processing may be performed on a plurality of network devices 102 in parallel.

FIG. 17 illustrates a process of the driver agent 602 of a client apparatus 103 when a request for changing a registered link destination is received.

In S1700, it is determined whether or not a request for changing a registered link destination has been received from the management apparatus 101. If a request for changing a registered link destination has been received, the process proceeds to S1701. If such a request has not been received, the process ends. In S1701, the link destination registered in the client apparatus 103 is changed in accordance with the request for changing a registered link destination. In this embodiment, two types of changing requests may be receivable in S1605 and S1606. Thus, in the former case, the link destination is changed to the link to the Web page of the network device 102 to be monitored, and, in the latter case, the link destination is changed to the link to the detail information page of the target network device 102, which is held in the management apparatus 101. In S1702, the changed content is returned to the requester (the management apparatus 101).

FIGS. 18A and 18B illustrate information regarding a link destination held in the management apparatus 101. The information is stored in the DB 303 or the HD 205 of the management apparatus 101.

FIG. 18A illustrates information about a link destination regarding each network device 102, which can be registered in a client apparatus 103. For example, two link destinations are set for MFP 001. One of the link destinations may be the destination of a link (link ID: 001-R) obtained when the Web page of MFP 001 is available in the PUSH mode, and the other link destination is the destination of a link (link ID: 001-D) obtained when the Web page of MFP 001 is not available. In addition, Server written in the last column of the table refers to the management apparatus 101, which is used as a link to the driver download screen in the PULL mode.

FIG. 18B illustrates information about a link destination actually registered as an environment variable in a client apparatus 103. The information is stored when a link destination is set in processing such as S1008 in FIG. 10B or S1607 in FIG. 16. Further, if a plurality of link destinations are registered for one client apparatus 103, one-to-multiple relation may be established between the client apparatuses 103 and link IDs. For example, two types of link IDs, namely, 001-R and 002-R, are assigned to PC 001. This means that links to the Web page of MFP 001 and the Web page of Printer 001 are registered for PC 001.

With the above process, information about a link destination that is registered as an environment variable in a client apparatus and that is used on the Device Stage can be updated in accordance with the state of the network device.

In the embodiments of the present invention, it is not described that a user is notified when a registered link destination is changed. However, by way of example, after the change, a changing notification may be sent via message box.

The present invention can also be realized by executing the following process. That is, a process in which a software (program) that realizes the functions of the above-described embodiments is supplied to the system or apparatus via a network or a recording medium of various types, and then a computer of the system or apparatus (or devices such as CPU or MPU) reads out the program and executes it. In such a case, the recording medium where the program is stored as well as the program are included in the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-253075, filed Nov. 4, 2009, which is hereby incorporated by reference herein in its entirety.

1. A management apparatus that communicates with a client apparatus on which a management program for managing a network device operates, comprising:
a determination unit configured to determine whether or not a network device has a function for providing a page of device information indicative of information relating to the network device; and
a transmission unit configured to transmit link information about a link to the page of the device information to the client apparatus when the determination unit determines that the network device has the function for providing the page of the device information, and configured to transmit link information that allows checking of device information held in the management apparatus to the client apparatus when the determination unit determines that the network device does not have the function for providing the page of the device information,
wherein in the client apparatus, the information relating to the network device is checked by using the transmitted link information via the management program.

2. The management apparatus according to claim 1, further comprising a mode determination unit configured to determine whether a mode for installing a driver corresponding to a network device into the client apparatus is a PUSH mode or a PULL mode,
wherein when the mode determination unit determines that the mode is the PUSH mode, the transmission unit transmits link information according to a determination result obtained by the determination unit, and when the mode determination unit determines that the mode is the PULL mode, the transmission unit transmits link information about a link to a page from which the driver corresponding to the network device is downloaded.

3. The management apparatus according to claim 1, further comprising a storage unit configured to store the link information transmitted from the transmission unit to the client apparatus and information about a relation with the client apparatus.

4. The management apparatus according to claim 1, further comprising:
an obtaining unit configured to obtain a state of the network device; and
a request unit configured to make a request to change link information that is used by the management program, by transmitting link information that allows checking of the device information held in the management apparatus to the client apparatus when it is determined, based on the state of the network device obtained by the obtaining unit, that the function for providing the page of the device information is not usable.

5. An information processing method for a management apparatus, comprising:
communicating with a client apparatus on which a management program for managing a network device operates;
determining whether or not a network device has a function for providing a page of device information indicative of information relating to the network device; and
transmitting link information about a link to the page of the device information to the client apparatus when it is determined that the network device has the function for providing the page of the device information, and transmitting link information that allows checking of device information held in the management apparatus to the client apparatus when it is determined that the network device does not have the function for providing the page of the device information,
wherein in the client apparatus, the information relating to the network device is checked by using the transmitted link information via the management program.

6. The information processing method according to claim 5, further comprising determining whether a mode for installing a driver corresponding to a network device into the client apparatus is a PUSH mode or a PULL mode,
wherein in the transmitting, when it is determined that the mode is the PUSH mode, link information according to an obtained determination result is transmitted, and when it is determined that the mode is the PULL mode, link information about a link to a page from which the driver corresponding to the network device is downloaded is transmitted.

7. The information processing method according to claim 5, further comprising storing the link information transmitted to the client apparatus in the transmitting and information about a relation with the client apparatus.

8. A computer readable storage medium on which is stored a computer program for making a computer execute a method for a management apparatus, the method comprising the steps of:
communicating with a client apparatus on which a management program for managing a network device operates;
determining whether or not a network device has a function for providing a page of device information indicative of information relating to the network device; and
transmitting link information about a link to the page of the device information to the client apparatus when it is determined that the network device has the function for providing the page of the device information, and transmitting link information that allows checking of device information held in the management apparatus to the client apparatus, the link information being held in the management apparatus, when it is determined that the network device does not have the function for providing the page of the device information,
wherein in the client apparatus, the information relating to the network device is checked by using the transmitted link information via the management program.

9. A client apparatus that communicates with a management apparatus and on which a management program for managing a network device operates, comprising:
a receiving unit configured to receive link information for checking device information indicative of information relating to a network device from the management apparatus; and
a registration unit configured to register the link information received by the receiving unit as information referred to by the management program,
wherein the registration unit registers the link information, and the information relating to the network device is displayed in accordance with an instruction via the management program.

10. An information processing method for a client apparatus that communicates with a management apparatus and on which a management program for managing a network device operates, comprising:
receiving link information for checking device information indicative of information relating to a network device from the management apparatus; and
registering the received link information as information referred to by the management program,
wherein in the registering, the link information is registered, and the information relating to the network device is displayed in accordance with an instruction via the management program.

11. A computer readable storage medium on which is stored a computer program for making a computer execute a method for managing a network device, the method comprising the steps of:
receiving link information for checking device information indicative of information relating to a network device from the management apparatus; and
registering the received link information as information referred to by the management program,
wherein in the registering, the link information is registered, and the information relating to the network device is displayed in accordance with an instruction via the management program.
